(19) United States
(12) Patent Application Publication
(10) Pub. No.: US 2003/0168187 A1
(43) Pub. Date: Sep. 11, 2003

(54) Battery-operated electric blind

(75) Inventors: Yu-Che Wen, Taoyuan Hsien (TW); Ya-Wei Hsu, Hsin Cu City (TW)

Correspondence Address: BROWDY AND NEIMARK, P.L.L.C., 624 NINTH STREET, NW, SUITE 300, WASHINGTON, DC, 20001-5303, US

(73) Assignee: INDUSTRIAL TECHNOLOGY RESEARCH INSTITUTE, Hsinchu Hsien (TW)

(21) Appl. No.: 10/143,957

(22) Filed: May 14, 2002

(30) Foreign Application Priority Data
Mar. 7, 2002 (TW) 91202680

(51) Int. Cl. E06B 9/30

(52) U.S. Cl. 160/168.1 P

(57) ABSTRACT

A battery-operated electric blind is constructed to include a headrail having an outer frame surface and an inner frame surface defining a holding chamber, a slat set, a power drive installed in the holding chamber of the headrail and coupled to the slat set. The outer frame surface of the headrail has a battery chamber for holding a battery to provide electricity to the power drive. The battery chamber has an opening extended to the outside of the headrail.

### BACKGROUND OF THE INVENTION

1. Field of the Invention

The present invention relates to blinds and, more specifically, to a battery-operated electric blind, which enables the user to replace the battery conveniently.

2. Description of the Related Art

A regular electric Venetian blind, as shown in FIG. 1, comprises a headrail 1 defining a holding chamber, a bottom rail 2, a plurality of slats 3 arranged in parallel between the headrail 1 and the bottom rail 2, a power drive 4 installed in the holding chamber of the headrail 1. The power drive 4 comprises a transmission mechanism 5, a reversible motor 6, and a battery 7. The transmission mechanism 5 is coupled to the bottom rail 2 and/or the slats 3 by an amplitude modulation lift cord or frequency modulation lift cord. The motor 6 is coupled to the transmission mechanism 5. The battery 7 is electrically connected to the motor 6 to provide the motor 6 with the necessary working voltage, for enabling the motor 6 to drive the transmission mechanism 5 in lifting the bottom rail 2 and the slats 3, or tilting the slats 3. Due to limited service life, the battery 7, either dry type or storage type, must be replaced when battery power was low. However, because the battery 7 is mounted inside the holding chamber of the headrail 1 behind its front sidewall, it is difficult to access to the battery 7. When replacing the battery 7, the user has to insert the hand through the top open side of the headrail 1 to pick up the battery 7. If the headrail 1 is directly attached to the ceiling 8 and stopped against the pilaster 9, the user must detach or tilt the headrail 1 from the ceiling 8 when replacing the battery 7.

### SUMMARY OF THE INVENTION

The present invention has been accomplished under the circumstances in view. It is therefore the main object of the present invention to provide a battery-operated electric blind, which enables the user to detach the battery for a replacement conveniently.

To achieve this object of the present invention, the battery-operated electric blind comprises a headrail having an outer frame surface and an inner frame surface defining a holding chamber, a slat set, and a power drive installed in the holding chamber of the headrail and coupled to the slat set. The outer frame surface of the headrail is provided with a battery chamber adapted for holding a battery which is electrically connected to the power drive. The battery chamber has an opening extended to the outside of the headrail through which the battery is inserted into the battery chamber.

### BRIEF DESCRIPTION OF THE DRAWINGS

FIG. 1 is a perspective view of a battery-operated electric blind according to the prior art.

FIG. 2 is a perspective exploded view of a battery-operated electric blind according to a first embodiment of the present invention.

FIG. 3 is a top view of the battery-operated electric blind shown in FIG. 2.

FIG. 4 is a perspective exploded view of a battery-operated electric blind according to a second embodiment of the present invention.

FIG. 5 is a top view of the battery-operated electric blind shown in FIG. 4.

FIG. 6 is a perspective exploded view of a battery-operated electric blind according to a third embodiment of the present invention.

FIG. 7 is a side view of the battery-operated electric blind shown in FIG. 6.

FIG. 8 is a perspective exploded view of a battery-operated electric blind according to a fourth embodiment of the present invention.

FIG. 9 is a top view of the battery-operated electric blind shown in FIG. 8.

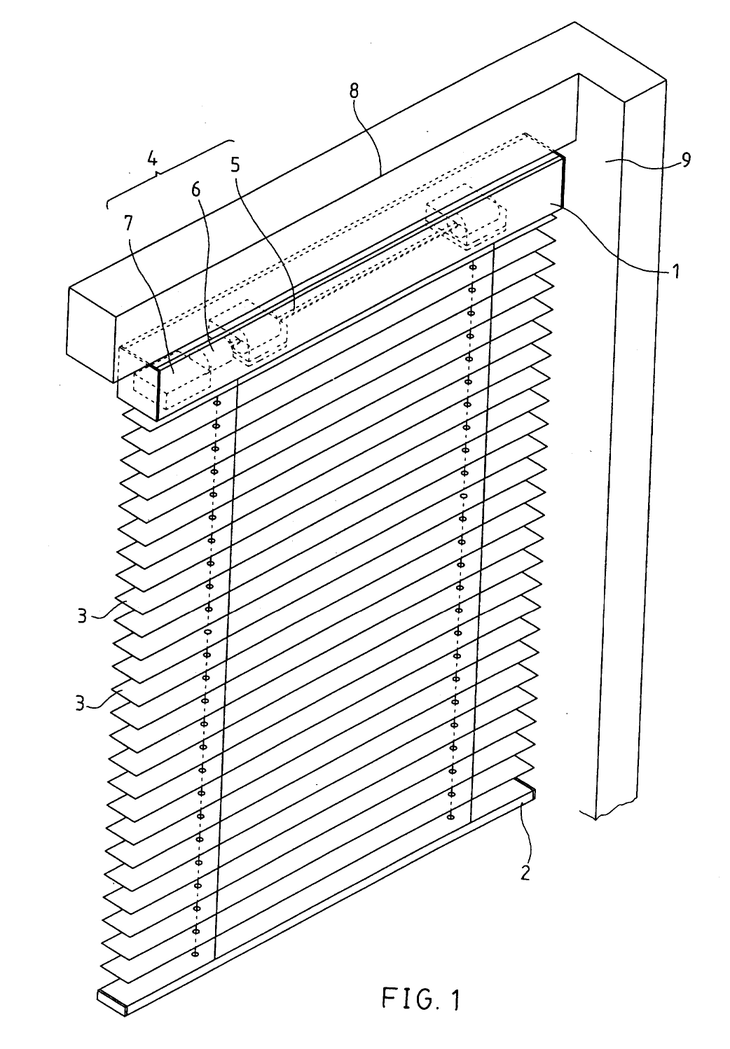

### DETAILED DESCRIPTION OF THE PREFERRED EMBODIMENT

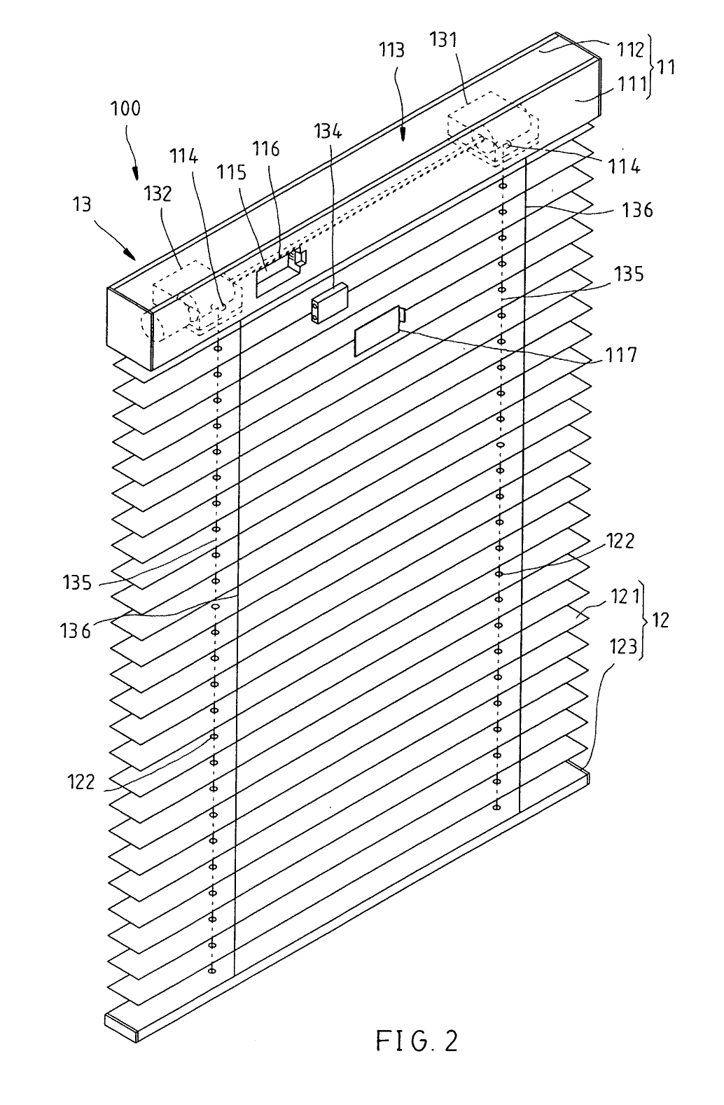

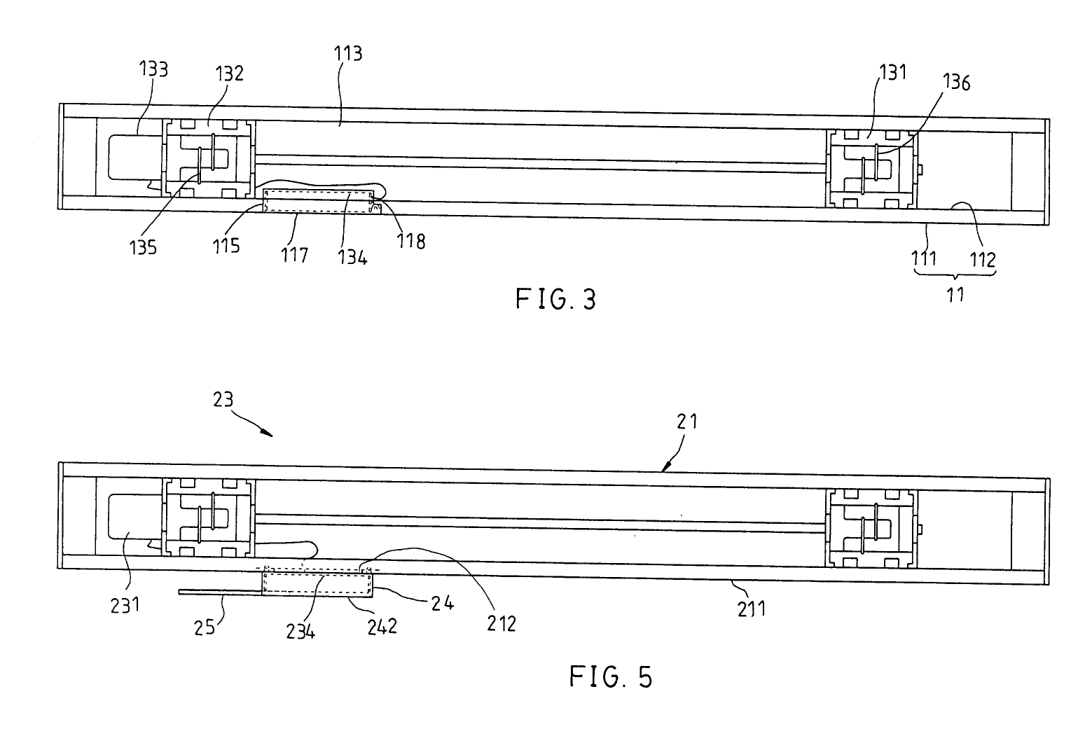

Referring to FIGS. 2 and 3, a battery-operated electric blind 100 in accordance with a first embodiment of the present invention is shown comprised of a headrail 11, a slat set 12, and a power drive 13.

The headrail 11 is fixedly mounted on the top side of the window (not shown). The headrail has an outer frame surface 111 and an inner frame surface 112 that defines a top-open holding chamber 113 therein. The headrail 11 has two through holes 114 bilaterally disposed at the bottom thereof in communication with the holding chamber 113, and a front recess disposed at a front side of the outer frame surface and forming a battery chamber 115. The battery chamber 115 has a front opening 116 in the front side of the outer frame surface 111 in communication with the outside, and an inner through hole 118 in communication with the holding chamber 113. Further, a battery lid 117 is provided for closing the front opening 116 of the battery chamber 115.

The slat set 12 is comprised of a plurality of slats 121 and a bottom rail 123. Each slat 121 has two wire holes 122 corresponding to the through holes 114 of the headrail 11.

The power drive 13 comprises an amplitude modulation control unit 131, a frequency modulation control unit 132, a motor unit 133, and a battery 134.

The amplitude modulation control unit 131 is installed in the holding chamber 113 of the headrail 11, comprising two amplitude modulation lift cords 135 respectively inserted through the through holes 114 and the wire holes 122 of each slat 121 and then fixedly connected to the bottom rail 123 for controlling lifting and positioning of the bottom rail 123 to adjust the extending area of the slats 121. The frequency modulation control unit 132 is installed in the holding chamber 113 of the headrail 11, comprising two frequency modulation lift cords 136 respectively inserted through the through holes 114 and fixedly connected to the slats 121 and the bottom rail 123 for controlling tilting of the slats 121 to regulate the amount of light passing through. The motor unit 133 is installed in the holding chamber 113 and connected to the amplitude modulation control unit 131 and the frequency modulation control unit 132, and controlled to drive the amplitude modulation control unit 131 and the frequency modulation control unit 132. The battery 134 can be a dry battery (cylindrical battery, rectangular battery, mercury battery, etc.) or storage battery (planar rechargeable battery) that provides the motor unit 133 with the necessary working voltage. The battery 134 is inserted through the opening 116 into the inside of the battery chamber 115, and secured to the electric contact terminals (not shown) in the battery chamber 115. The electric contact terminals are electrically connected to the motor unit 133 by an electric wire being extended through the inner through hole 118. After installation of the battery 134 in the battery chamber 115, the battery lid 134 is fastened to the opening 116 to stop the battery 134 inside the battery chamber 115 and to keep the battery chamber 115 from sight.

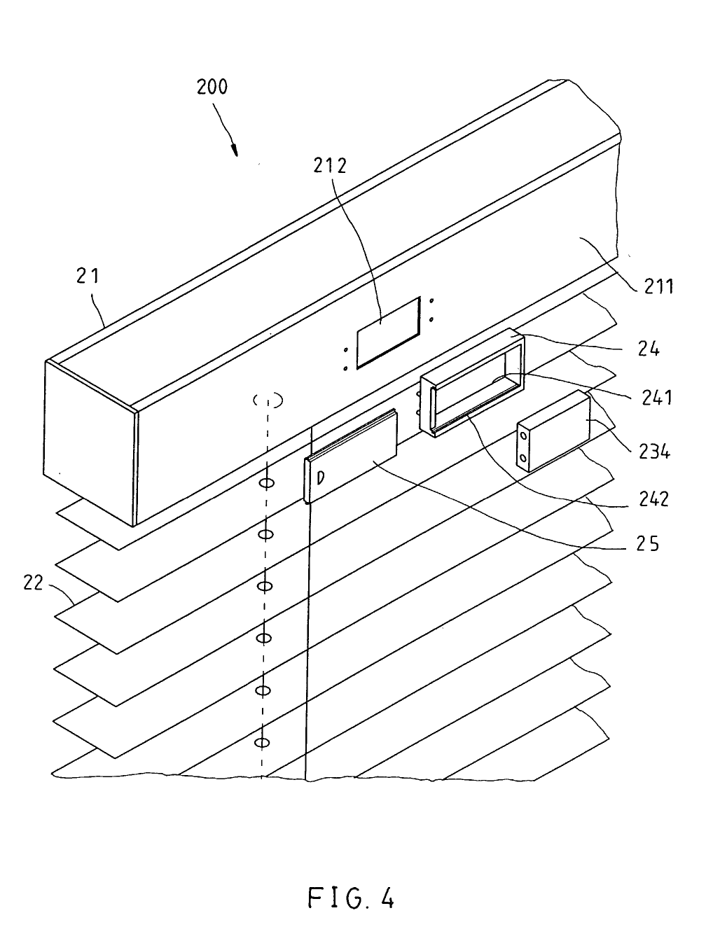

FIGS. 4 and 5 show a battery-operated electric blind 200 constructed according to a second embodiment of the present invention. Similar to the aforesaid first embodiment of the present invention, the battery-operated electric blind 200 is comprised of a headrail 21, a slat set 22, and a power drive 23. The headrail 21 has a through hole 212. A battery holder 24 is fixedly fastened to the outer frame surface 211 of the headrail 21 and provided with a battery chamber 241 for receiving a battery 234. The battery holder 24 has an opening 242 disposed in communication with the battery chamber 241 and the outside, and electric contact means (not shown) electrically connected to the motor unit 231 of the power drive 23 and adapted to contact the terminals of the battery 234. Further, the battery holder 24 is provided with a lid 25. After installation of the battery 234 in the battery holder 24, the battery chamber 241 is closed with the lid 25.

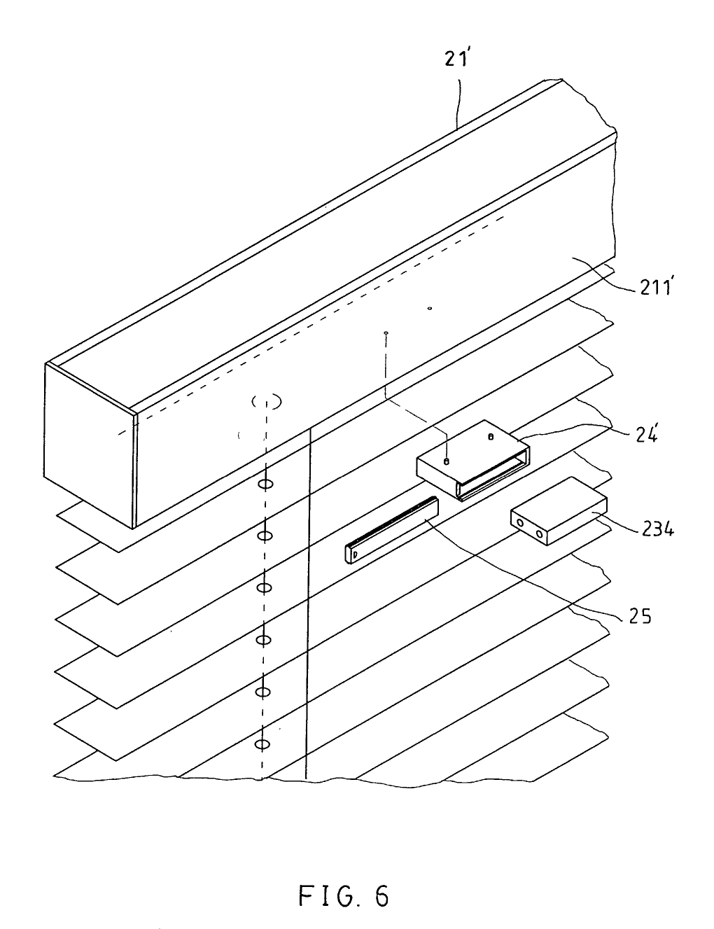

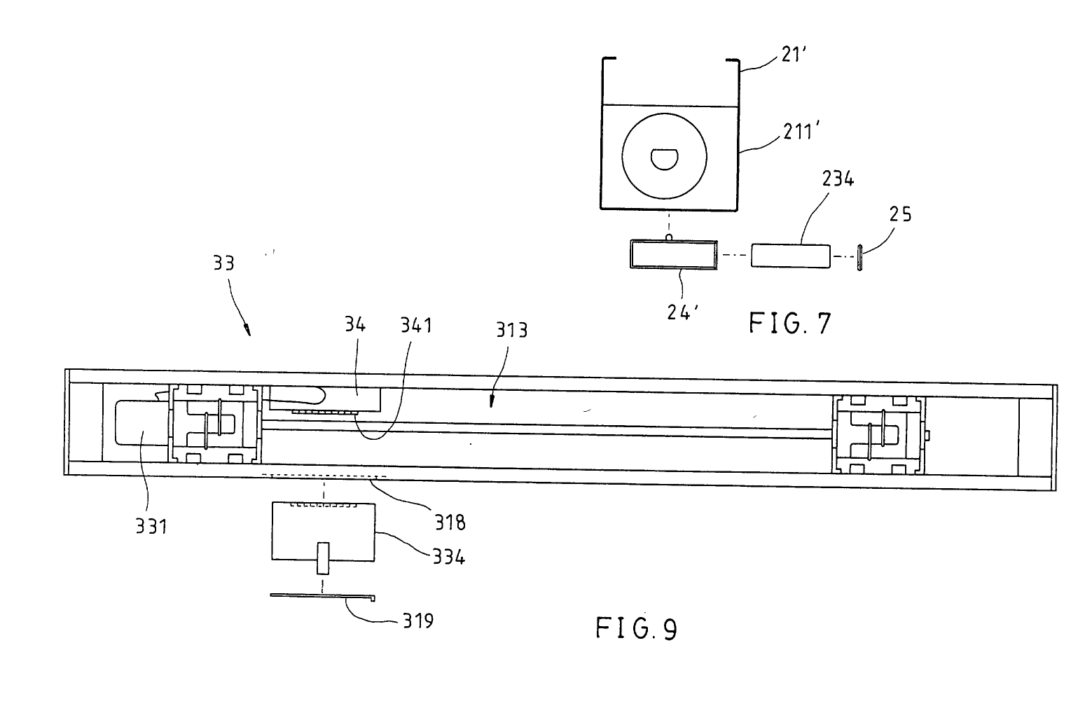

FIGS. 6 and 7 show a third embodiment of the present invention. According to this embodiment, the battery holder 24′ is installed in the bottom side of the outer frame surface 211′ of the headrail 21′.

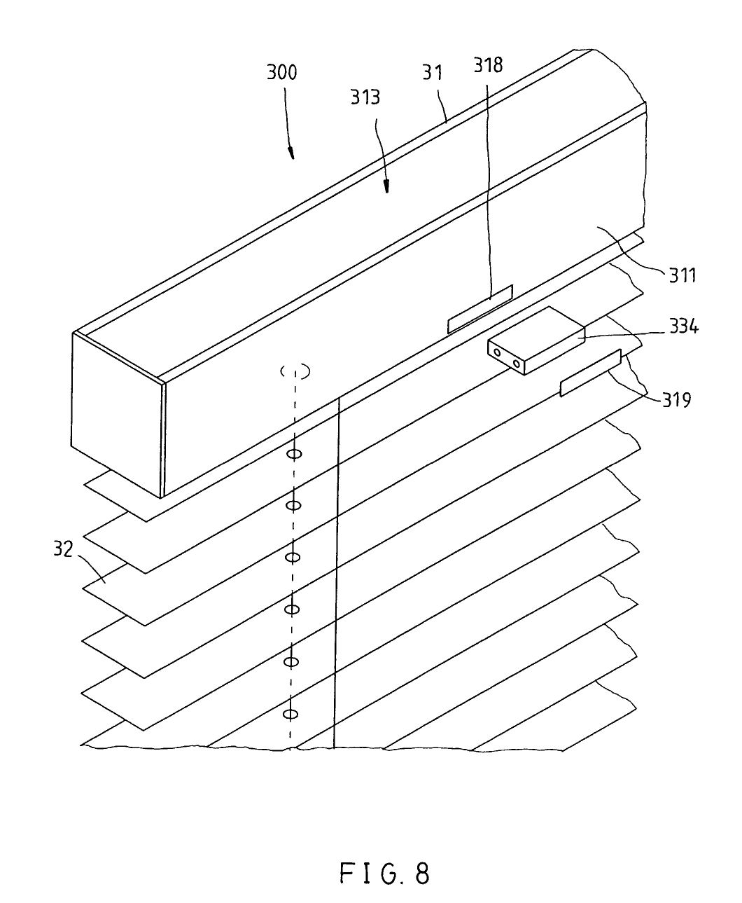

FIGS. 8 and 9 show a battery-operated electric blind 300 according to a fourth embodiment of the present invention. Similar to the aforesaid embodiments of the present invention, the battery-operated electric blind 300 is comprised of a headrail 31, a slat set 32, and a power drive 33. The outer frame surface 311 of the headrail 31 has an opening 318 disposed in communication with the holding chamber 313 of the headrail 31. A battery holder 34 is provided inside the holding chamber 313, having electric contact terminals 341 electrically connected to the motor unit 331 of the power drive 33 and adapted for contacting the terminals of the battery 334. After insertion of the battery 334 through the opening 318 into the battery holder 34 and set into contact with the electric contact terminals 341, a lid 319 is fastened to the outer frame surface 311 to close the opening 318.

What the invention claimed is:

1. A battery-operated electric blind comprising:
a headrail, said headrail having an outer frame surface and an inner frame surface defining a holding chamber;
a slat set;
a power drive installed in said holding chamber of said headrail and coupled to said slat set;
wherein said outer frame surface of said headrail has a battery chamber for holding a battery which is electrically connected to said power drive, said battery chamber having an opening extended to the outside of said headrail.

2. The battery-operated electric blind as claimed in claim 1, further comprising a lid adapted to close the opening of said battery chamber.

3. The battery-operated electric blind as claimed in claim 1, wherein said outer frame surface of said headrail has a recess forming said battery chamber.

4. The battery-operated electric blind as claimed in claim 3, wherein said battery chamber has an inner through hole disposed in communication with the holding chamber of said headrail, and conductor means inserted through said inner through hole and electrically connected to said power drive.

5. The battery-operated electric blind as claimed in claim 1, further comprising a battery holder fixedly mounted on said outer frame surface and defining said battery chamber, and the opening of said battery chamber formed in one side of said battery holder.

6. A battery-operated electric blind comprising:
a headrail, said headrail having an outer frame surface and an inner frame surface defining a holding chamber;
a slat set;
a power drive installed in said holding chamber of said headrail and coupled to said slat set;
wherein said headrail has an opening disposed in communication with said holding chamber, and a battery holder fixedly mounted inside said holding chamber corresponding in location to said opening and electrically connected to said power drive such that a battery is inserted through said opening into said battery holder to provide electricity to said power drive.

7. The battery-operated electric blind as claimed in claim 6, further comprising a lid adapted to close the opening of said headrail.

8. The battery-operated electric blind as claimed in claim 7, wherein said battery holder comprises electric contact terminal means electrically connected to said power drive and facing the opening for contacting the battery to be inserted through the opening into said battery holder.
